(19) United States
(12) Patent Application Publication
(10) Pub. No.: US 2013/0077701 A1
(43) Pub. Date: Mar. 28, 2013

(54) METHOD AND INTEGRATED CIRCUIT FOR ADJUSTING THE WIDTH OF AN INPUT/OUTPUT LINK

(71) Applicants: Benjamin Tsien, Fremont, CA (US); Kevin M. Lepak, Austin, TX (US); Paul C. Miranda, Austin, TX (US); William A. Hughes, San Jose, CA (US); Wade L. Williams, Austin, TX (US); Chenping Yang, Fremont, CA (US); Adam L. From, Austin, TX (US)

(72) Inventors: Benjamin Tsien, Fremont, CA (US); Kevin M. Lepak, Austin, TX (US); Paul C. Miranda, Austin, TX (US); William A. Hughes, San Jose, CA (US); Wade L. Williams, Austin, TX (US); Chenping Yang, Fremont, CA (US); Adam L. From, Austin, TX (US)

(73) Assignee: ADVANCED MICRO DEVICES, INC., Sunnyvale, CA (US)

(21) Appl. No.: 13/243,086

(22) Filed: Sep. 23, 2011

(51) Int. Cl. H04L 27/00

(52) U.S. Cl. 375/259

(57) ABSTRACT

A method and apparatus are described for adjusting a bit width of an input/output (I/O) link established between a transmitter and a receiver. The I/O link has a plurality of bit lanes. The transmitter may send to the receiver a command identifying at least one selected bit lane of the I/O link that will be powered off or powered on in response to detecting that a bit width adjustment threshold of the I/O link has been reached.

### FIELD OF INVENTION

The present invention is generally directed to dynamically adjusting the width of an input/output (I/O) link in response to changes to the amount of traffic on the link.

### BACKGROUND

In a conventional computer system, on-die high speed links are used to transmit data across multiple processor nodes and/or I/O devices. These links contribute to a substantial percentage of the overall socket power of the computer system. However, not all workloads take advantage of the maximum bandwidth supplied via these links at all times. Although the processors may be idle, or there is a light workload, traffic may still be routed using the full bandwidth of HyperTransport™, even though a small amount of real information is being transmitted across the links. This unnecessarily wastes power. One way to reduce power consumption, and thus to increase performance per watt, is to reduce the link width and power off the extra lanes when the workload does not demand the maximum bandwidth.

HyperTransport™ is a technology for interconnection of computer processors. HyperTransport™ is a bidirectional serial/parallel high-bandwidth, low-latency point-to-point link. More generally, HyperTransport™ is a high-speed, high performance point-to-point link. HyperTransport™ comes in various speed versions, (e.g., 1.x, 2.0, 3.0, and 3.1), which run from 200 MHz to 3.2 GHz. HyperTransport™ supports an auto-negotiated bit width, ranging from two-link to 32-link interconnects. The full-width, full bandwidth, 32-bit interconnect has a transfer rate of 25.6 gigabyte (GB)/second, (3.2 GHz/link×2 bits/Hz×32 links×1 byte÷8 bits), per direction, or 51.2 GB/second aggregated bandwidth per link, making it faster than any existing bus standard for personal computer workstations and servers, (such as PCI Express), as well as making it faster than most bus standards for high-performance computing and networking. Links of various widths can be mixed together in a single system (for example, one 16-link interconnect to another CPU and one 8-link interconnect to a peripheral device), which allows for a wider interconnect between processors, and a lower bandwidth interconnect to peripherals as appropriate. It also supports link splitting, where a single 16-link interconnect can be divided into two 8-link interconnects. The technology also typically has lower latency than other solutions due to its lower overhead.

Current computer systems are either incapable of dynamically adjusting power consumption via narrowing the links, or may impose large protocol overheads where links may remain in suboptimal widths or in total link blackout state for a prolonged period during which no data may be transmitted, which results in performance penalties. In order to minimize performance loss while maximizing power reduction, the frequency of link narrowing attempts is reduced by tuning down the aggressiveness of the decision engine. Thus, large performance penalties may be imposed while leaving potential performance per watt upsides untapped.

In existing customer server installations, the servers may actually remain relatively idle for a large percentage of time each day. In one conventional procedure for implementing power management of HyperTransport™ links, a link width reduction may be requested. The width of a link between a transmitter (initiator) and a receiver (responder) may be reduced from an original 16-bit full link, to one of an 8-bit reduced link, a 4-bit reduced link, a 2-bit reduced link or a 1-bit reduced link, each bit representing a lane. In addition, clock and control lanes are used to facilitate communications between the transmitter and the receiver.

In accordance with the conventional procedure, after a link width change is requested via a centralized dynamic link width (CDLW), a new link width is applied and the necessary trainings are performed if the new width involves waking inactive lanes from their low power states. However, a data transmission blackout of many cycles may occur during link-width transitions that may affect server responsiveness, and even if lightly loaded, there may be a performance impact due to latency sensitivity. The transmission data blackout may affect all cores in the system, and cause the data transmission load to be unevenly distributed across the cores in the server. With multiple links in the system, some links may be more heavily utilized than others. Therefore, it would be desirable to be able to manage links one at a time without affecting others in the system. Furthermore, the link width cannot be adjusted without training all lanes, thus imposing a larger blackout period and affecting both narrow and widen operations. A method and apparatus is desired that reduces the link width to save power while enhancing performance per watt of the link.

### SUMMARY OF EMBODIMENTS

A method and apparatus are described for adjusting a bit width of an input/output (I/O) link established between a transmitter and a receiver. The I/O link has a plurality of bit lanes. The transmitter may send to the receiver a command identifying at least one selected bit lane of the I/O link that may be powered off or powered on in response to detecting that a bit width adjustment threshold of the I/O link has been reached.

The command may be a narrow link command that indicates to the receiver when data transmitted by the transmitter will be sent at a narrowed width. The transmitter may terminate the transmission of data over the at least one selected bit lane identified by the narrow link command while continuing transmit data over at least one active bit lane of the I/O link. The transmitter may power off the at least one selected bit lane identified by the narrow link command. The receiver may power off the at least one selected bit lane identified by the narrow link command while continuing to receive data from the transmitter over at least one active bit lane of the I/O link. The receiver may transmit an acknowledgement message to the transmitter after the at least one selected bit lane identified by the narrow link command has been powered off.

The command may be a widen link command. The transmitter and the receiver may power on the at least one selected bit lane identified by the widen link command while the transmitter continues to transmit data to the receiver over at least one active bit lane of the I/O link. The receiver may transmit an acknowledgement message to the transmitter after the at least one selected bit lane identified by the widen link command has been powered on. The transmitter and the receiver may perform an I/O link training procedure. The transmitter, the receiver and the I/O link may be incorporated into an integrated circuit (IC).

In another embodiment, a computer-readable storage medium may be configured to store a set of instructions used for manufacturing a semiconductor device. The semiconductor device may comprise the transmitter, the receiver and the I/O link. The instructions may be Verilog data instructions or hardware description language (HDL) instructions.

### BRIEF DESCRIPTION OF THE DRAWINGS

A more detailed understanding may be had from the following description, given by way of example in conjunction with the accompanying drawings wherein:

FIG. 1A shows an example of a 16-bit link operating at 100% capacity;

FIG. 1B shows an example of a 16-bit link operating at 50% capacity; and

FIGS. 2A, 2B, 2C and 2D, taken together, are a flow diagram of a procedure for adjusting a bit width of an I/O link established between a transmitter and a receiver in a multi-processor system.

### DETAILED DESCRIPTION OF EMBODIMENTS

In one embodiment of the present invention, traffic on each direction of each transmission link is sampled over a window of time upon power up. A determination is made as to how much of the available capacity of the transmission link is being utilized (active) versus how much remains idle (inactive). Based upon this determination, the capacity of the link is narrowed. For example, if the percentage of the capacity of the full link that is being used is less than 25%, the link may be narrowed by 50%, resulting in less than 50% capacity at the new width. If the link is less than 12.5% of full capacity, for example, then it may be narrowed to 25%, resulting in 50% capacity at that width; if greater than 50% of the capacity of the 25% is being used, then the link may be widened.

In another embodiment, different utilization thresholds may be chosen for entering into narrowed links. A determination may be made as to whether a workload stays within the thresholds for a proposed narrowed width, entirely, or for a percentage of a time window, before committing to a change to that narrowed width. In this embodiment, one may also favor the link for widening by detecting conditions in which the observed bandwidth is vastly greater than the set threshold. External factors also may be used to dynamically adjust the utilization thresholds.

For example, one may count the number of processor cores on a node that are in higher performance states and determine whether to narrow or widen the link width, based on whether the count is higher or lower than a threshold.

Alternatively, feedback may not be utilized at all. Instead, a static approach that utilizes a central processing unit (CPU) state may be implemented. If all cores are at a lower power state (p-state), then the link width may be reduced (e.g., the capacity is reduced from 16 bit to 8 bit width links).

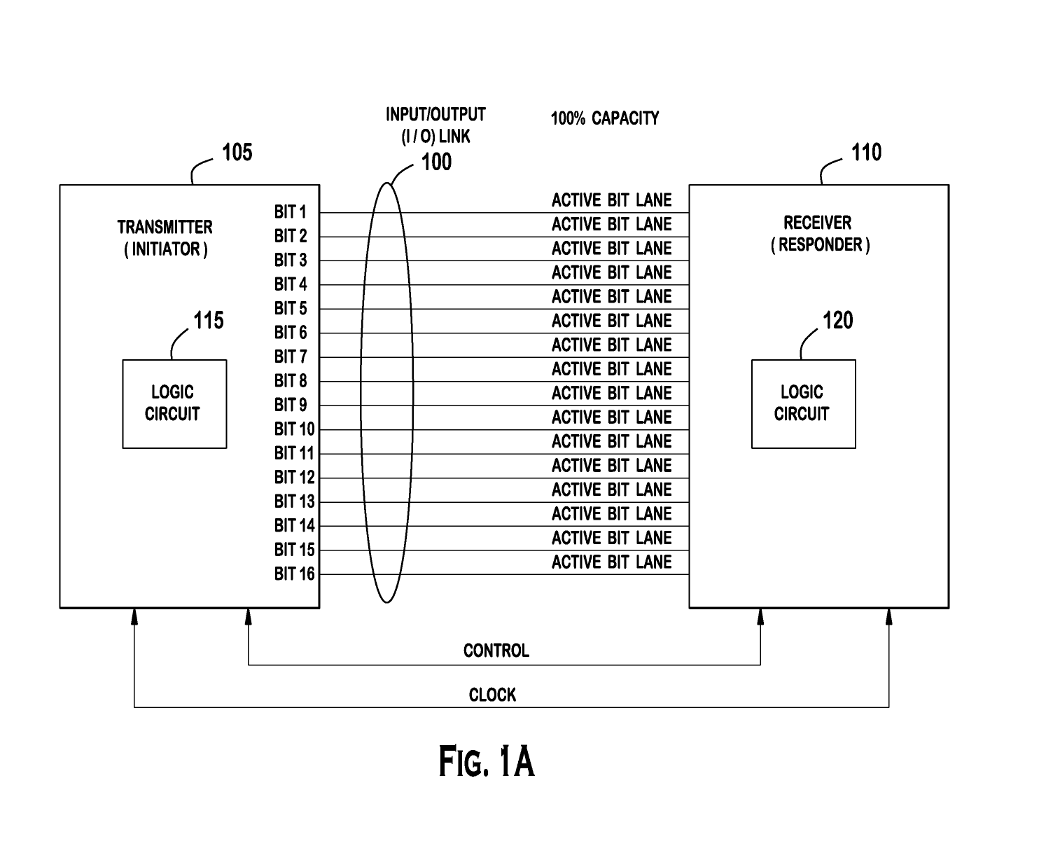

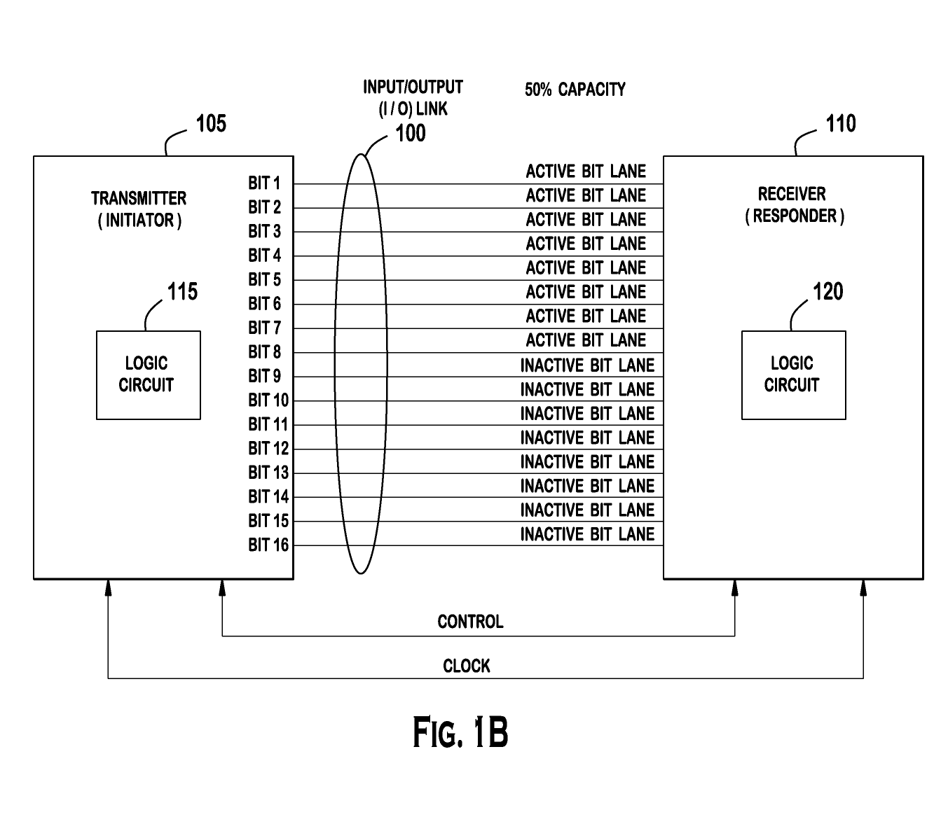

FIG. 1A shows an example of a 16-bit I/O link 100 operating at 100% capacity between a transmitter (i.e., initiator) 105 and a receiver (i.e., responder) 110, and FIG. 1B shows an example of the 16-bit I/O link 100 operating at 50% capacity. The transmitter 105 may include a logic circuit 115, and the receiver 110 may include a logic circuit 120. The I/O link 100 may be a HyperTransport™ I/O link. As would be understood by one of ordinary skill, the I/O link 100 may have any desired number of bits as designated by the designer.

The transmitter 105 may reside on a first die, and the receiver 110 may reside on a second die. The transmitter 105 may be comprised by a first I/O logic device, and the receiver 105 may be comprised by a second I/O device. The transmitter 105 may be comprised by a first processor, and the receiver 110 may be comprised by a second processor in a multi-processor system. The transmitter 105 may be comprised by a first router, and the receiver 110 may be comprised by a second router.

In one embodiment, a method of adjusting a bit width of the I/O link 100 established between the transmitter 105 and the receiver 110 may be implemented. The I/O link 100 may have a plurality of bit lanes. The transmitter 105 may transmit data to the receiver 110 over a plurality of active bit lanes of the I/O link 100. The transmitter 105 may send to the receiver 110 a command identifying at least one selected bit lane of the I/O link 100 that will be powered off or powered on in response to detecting that a bit width adjustment threshold of the I/O link 100 has been reached.

The command may be a narrow link command that indicates to the receiver 110 when data transmitted by the transmitter 105 will be sent at a narrowed width. The transmitter 105 may terminate the transmission of data over the at least one selected bit lane identified by the narrow link command while continuing to transmit data over at least one active bit lane of the I/O link 100. The transmitter 105 may power off the at least one selected bit lane identified by the narrow link command. The receiver 110 may power off the at least one selected bit lane identified by the narrow link command while continuing to receive data from the transmitter 105 over at least one active bit lane of the I/O link 100. The receiver 110 may transmit an acknowledgement message to the transmitter 105 after the at least one selected bit lane identified by the narrow link command has been powered off.

The command may be a widen link command. The transmitter 105 and the receiver 110 may power on the at least one selected bit lane identified by the widen link command while the transmitter 105 continues to transmit data to the receiver 110 over at least one active bit lane of the I/O link 100. The receiver 110 may transmit an acknowledgement message to the transmitter 105 after the at least one selected bit lane identified by the widen link command has been powered on. The transmitter 105 and the receiver 110 may perform an I/O link training procedure. The transmitter 105, the receiver 110 and the I/O link 100 may be incorporated into an integrated circuit (IC).

In another embodiment, a computer-readable storage medium may be configured to store a set of instructions used for manufacturing a semiconductor device. The semiconductor device may comprise the transmitter 105, the receiver 110 and the I/O link 100. The instructions may be Verilog data instructions or hardware description language (HDL) instructions.

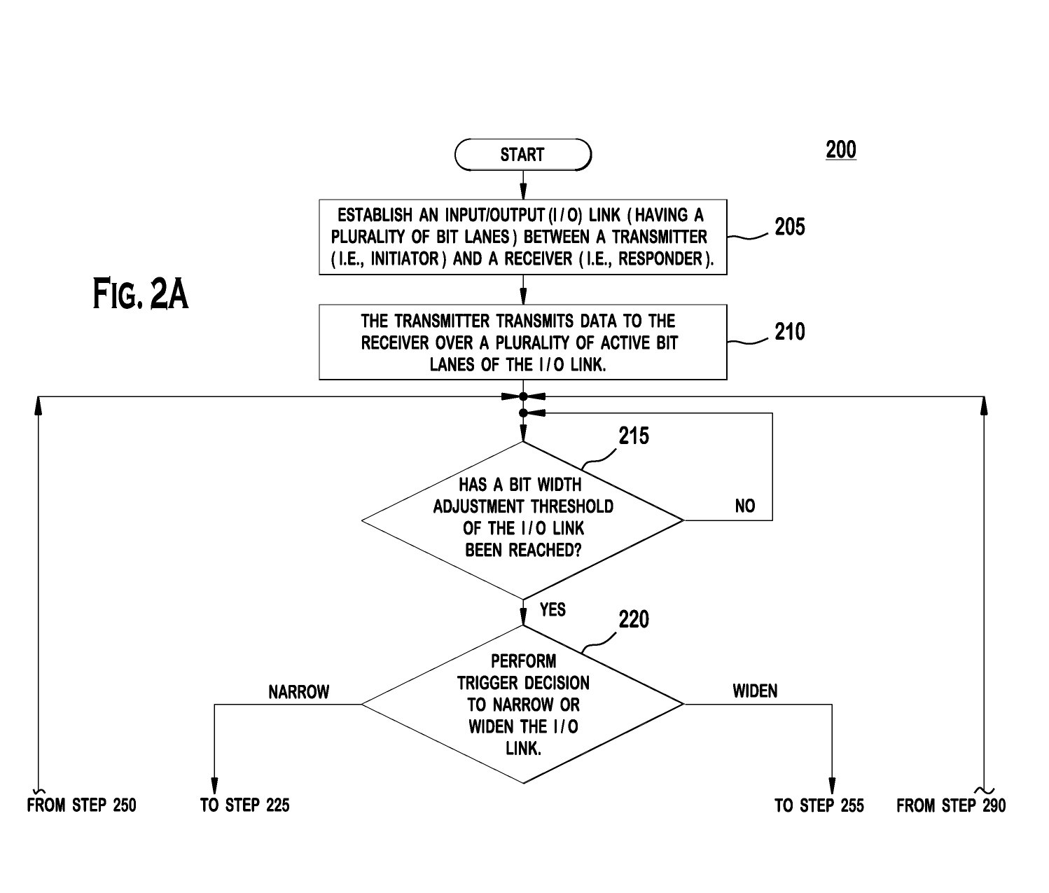

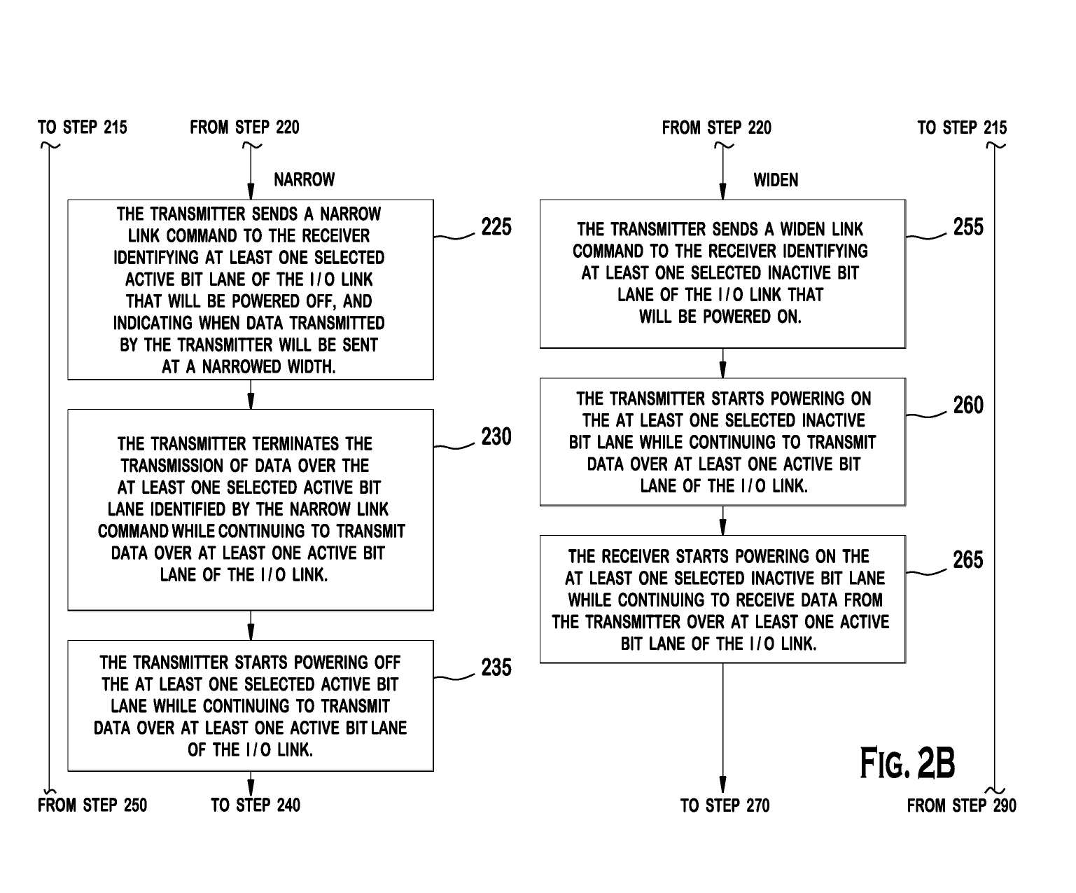

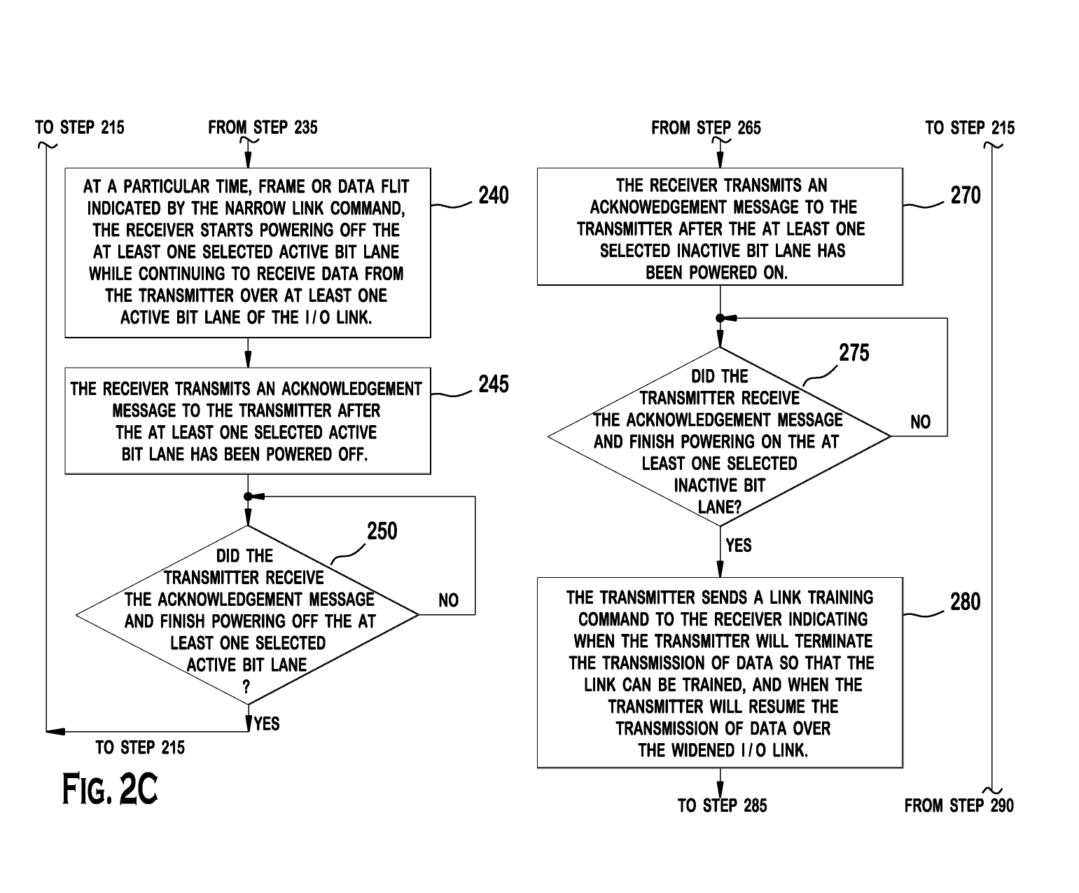

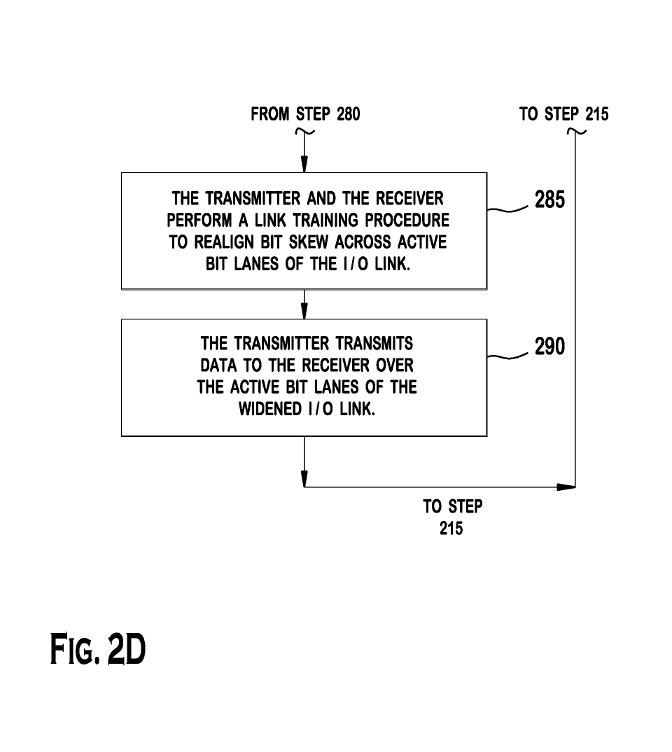

FIGS. 2A, 2B, 2C and 2D, taken together, are a flow diagram of a procedure 200 for adjusting a bit width of an I/O link 100 (e.g., a HyperTransport™ I/O link) having a plurality of bit lanes. In step 205, the I/O link 100 is established between a transmitter 105 (i.e., an initiator) and a receiver 110 (a responder). In step 210, the transmitter 105 transmits data to the receiver 110 over a plurality of active bit lanes of the I/O link 100. In step 215, a determination (i.e., a trigger decision) is made as to whether a bit width adjustment threshold of the I/O link 100 has been reached and, if so, a decision is made in step 220 as to whether to narrow or widen the I/O link 100.

If it is determined in step 220 to narrow the I/O link 100, the transmitter 105 in step 225 sends a narrow link command to the receiver 110 identifying at least one selected active bit lane of the I/O link 100 that will be powered off, and indicating when data transmitted by the transmitter 105 will be sent at a narrowed width. For example, the narrow link command may indicate that after a predetermined number of frames or data flits, the next frame or data flit will be transmitted over fewer bit lanes of the I/O link 100.

In step 230, the transmitter 105 terminates the transmission of data over the at least one selected active bit lane identified by the narrow link command while continuing to transmit data over at least one active bit lane of the I/O link 100. In step 235, the transmitter 105 starts powering off the at least one selected active bit lane while continuing to transmit data over at least one active bit lane of the I/O link 100. In step 240, at a particular time, frame or data flit indicated by the narrow link command, the receiver 110 starts powering off the at least one selected active bit lane while continuing to receive data from the transmitter 105 over at least one active bit lane of the I/O link 100. In step 245, the receiver 210 transmits an acknowledgement message to the transmitter 105 after the at least one selected active bit lane has been powered off. In step 250, a determination is made as to whether the transmitter 105 received the acknowledgement message and finished powering off the at least one selected active bit lane. If so, the procedure 200 returns to step 215.

If it is determined in step 220 to widen the I/O link 100, the transmitter 105 in step 255 sends a widen link command to the receiver 110 identifying at least one selected inactive bit lane of the I/O link 100 that will be powered on. In step 260, the transmitter 105 starts powering on the at least one selected inactive bit lane while continuing to transmit data over at least one active bit lane of the I/O link 100. In step 265, the receiver 110 starts powering on the at least one selected inactive bit lane while continuing to receive data from the transmitter 105 over at least one active bit lane of the I/O link 100. In step 270, the receiver 210 transmits an acknowledgement message to the transmitter 105 after the at least one selected inactive bit lane has been powered on.

In step 275, a determination is made as to whether the transmitter 105 received the acknowledgement message and finished powering on the at least one selected inactive bit lane. If so, the transmitter 105 in step 280 sends a link training command to the receiver 110 indicating when the transmitter 105 will terminate the transmission of data so that the link can be trained, and when the transmitter 105 will resume the transmission of data over the widened I/O link 100. For example, the link training command may indicate that after a predetermined number of frames or data flits, data transmission will be blacked out for a fixed training period, and then the next frame or data flit will be transmitted using the widened link. In step 285, the transmitter 105 and the receiver 110 perform a link training procedure to realign bit skew across active bit lanes of the I/O link 100. In step 290, the transmitter resumes transmitting data to the receiver 110 over the active bit lanes of the widened I/O link 100. The procedure 200 then returns to step 215.

Once a determination has been made to narrow the I/O link 100, (e.g., from 100% to 50%), or widen the I/O link 100, (e.g., from 100% to 50%), the receiver 105 and the transmitter 110 may communicate and synchronize the width change for the direction of the I/O link 100. On a narrowing action, the transmitter 105 may communicate a boundary point (via protocols on active lanes or otherwise), after which new packets may be communicated in the new width of the I/O link 100 to the receiver 110, so that both may switch at the same location in the protocol stream. Both the transmitter 105 and the receiver 110, after committing to the narrowed width, may power off the now inactive lanes while data is actively communicated on the active lanes.

On a widening action, the transmitter 105 may power on its inactive transmitting lanes and communicate to the receiver 110 to do the same to its inactive receiver lanes, (via protocols on active lanes or otherwise). During power up, data may still be transmitted on the active lanes that form the narrowed link. After power up, the receiver 110 may communicate, (via protocol on active lanes or otherwise), to the transmitter 105 after counting sufficient time, detecting a training pattern, or via another mechanism. The transmitter 105 may then communicate the boundary point, (via protocols or otherwise), after which new packets may be communicated in the new width to the receiver 110, so that both the transmitter 105 and the receiver 110 may switch at the same location in the protocol stream. On some implementations, a small blackout may be necessary to align the active lanes to the newly reactivated lanes prior to switching the protocol to the widened width. This blackout may be implicit at the boundary point or via a separate communication. Furthermore, there is no additional handshake required to signal completion of lane re-training from the receiver side for the newly reactivated lanes.

The transmitter 105 is the node that always initiates the change of width of a link. When a link width change is desired, the transmitter 105 may send at least one special encoded packet to the receiver 110 indicating that a link width change is desired and what bit width the transmitter wants to change the link width to. Various different thresholds may be used to determine whether the link width should be widened or narrowed.

In one embodiment, an (almost) instantaneous “utilization” trigger may be used to count the number of cycles a link is not sending non-network optimization protocol (NOP) packets inside a window. The utilization may be based on the ratio of non-NOP cycles versus total cycles. This measured utilization may then be extrapolated to all supported link widths. For example, if the link is operating at 50% capacity (half width), at a 25% utilization, then at 25% capacity (quarter width), the extrapolated utilization would be 50%. Likewise, at 100% capacity, the utilization would be 12.5%.

In another embodiment, a “pivot” threshold may be used to define a utilization level that is deemed “busy”. If utilization is above the pivot threshold for a given width, then it is “busy”, and if below, then it's “not busy”.

The pivot may be based on the number of cores in the highest performance state. In one embodiment, three different pivot numbers may be defined. One when the number of cores in the highest performance state is greater than a threshold, e.g., where a conservative approach is used to determine “busy” via a lower threshold value, another when no core is in the highest performance state, where the most aggressive approach used to determine “busy”, and another in between.

The pivot may be dynamically adjusted to be more conservative when in narrower widths, since the performance cost is greater in narrower widths. This may be done by scaling the “busy” threshold lower by a constant associated with the width.

Dynamic adjustments, also known as “dual band”, may be used to set up a second threshold to determine a “very busy” link state that is higher than “busy”. The threshold may be based on a fixed multiplier on the “busy” threshold for the width. This may be used to force a quicker response to widen a link.

A busy score may be determined at every window, such that the extrapolated instantaneous utilization for all widths is compared against the dynamically adjusted pivots. A utilization exceeding the pivot may be deemed as a busy event and is counted. The busy score may be calculated by counting the percentage of busy events within a fixed number of preceding windows. An implementation can either keep a historically accurate count of busy events in fixed number of preceding windows, approximate it by taking snapshots and storing the busy score at convenient times, or using some decay function to approximate the score. A busy score may thus be determined for all supported widths.

For a “very busy” event determined by the “dual band” method, one embodiment is to double-count it in the score.

A predetermined threshold may be used to compare against the busy score of the current width. If the busy score is greater than a “prevent narrow” threshold, then the link may not be permitted to narrow. Otherwise, a trigger may allow narrowing to the next width.

A predetermined threshold may be used to compare against the busy score of the current width. If the busy score is greater than the widen threshold, then the link is forced to a wider width. This may be the next wider width or more conservatively to a full width (e.g., take widen branch of step 220 of FIG. 2A). If the busy score is less than the threshold, then the link may not be allowed to widen.

The prevent narrow threshold should be less than the force widen threshold. Ideally, there's a dead zone between the two thresholds to provide stability from frequent changes.

Hysteresis may be used to block another width change until a timer expires for pathological workloads whose rapidly changing bandwidth demands interfere destructively with the trigger decisions, causing bouncing width changes and thus resulting in lower performance. A static or adaptive hysteresis may be applied to prevent performance loss from unhelpful width changes.

The above dynamic triggers may be replaced with static determination or chip level power management determination. For static determination, link width change decisions (narrow/width branches of step 220 of FIG. 2A) may be determined statically via software, controlled either directly by the operating system or through drivers according to performance or power profiles. For chip level power management determination, chip level (system-on-a-chip (SOC)) power management logic, either through hardware or firmware, may dynamically allocate/reallocate power between different processors to and from the links. For instance, if a processor is determined to be consuming less than its allocated power, its excess allocation may be given to allow a link to operate at full width instead of a default of half width. Likewise, if the trigger causes a link to be narrowed, then, for example, its excess allocated power can be given to boost a processor. This may be implemented either by hardware/firmware directly adjusting the link width or limiting the width choices available to the trigger according to its allocation.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), an accelerated processing unit (APU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of adjusting a bit width of an input/output (I/O) link established between a transmitter and a receiver, the I/O link having a plurality of bit lanes, the method comprising:
the transmitter sending to the receiver a command identifying at least one selected bit lane of the I/O link that will be powered off or powered on in response to detecting that a bit width adjustment threshold of the I/O link has been reached.

2. The method of claim 1 wherein the command is a narrow link command that indicates to the receiver when data transmitted by the transmitter will be sent at a narrowed width.

3. The method of claim 2 further comprising:
the transmitter terminating the transmission of data over the at least one selected bit lane identified by the narrow link command while continuing to transmit data over at least one active bit lane of the I/O link.

4. The method of claim 3 further comprising:
the transmitter powering off the at least one selected bit lane identified by the narrow link command.

5. The method of claim 4 further comprising:
the receiver powering off the at least one selected bit lane identified by the narrow link command while continuing to receive data from the transmitter over at least one active bit lane of the I/O link.

6. The method of claim 5 further comprising:
the receiver transmitting an acknowledgement message to the transmitter after the at least one selected bit lane identified by the narrow link command has been powered off.

7. The method of claim 1 wherein the command is a widen link command, the method further comprising:
the transmitter and the receiver powering on the at least one selected bit lane identified by the widen link command while the transmitter continues to transmit data to the receiver over at least one active bit lane of the I/O link.

8. The method of claim 7 further comprising:
the receiver transmitting an acknowledgement message to the transmitter after the at least one selected bit lane identified by the widen link command has been powered on.

9. The method of claim 8 further comprising:
the transmitter and the receiver performing an I/O link training procedure.

10. An integrated circuit (IC) comprising:
a transmitter;
a receiver; and
an input/output (I/O) link established between the transmitter and the receiver, the I/O link having a plurality of bit lanes, wherein the transmitter is configured to send to the receiver a command identifying at least one selected bit lane of the I/O link that will be powered off or powered on in response to detecting that a bit width adjustment threshold of the I/O link has been reached.

11. The IC of claim 10 wherein the command is a narrow link command that indicates to the receiver when data transmitted by the transmitter will be sent at a narrowed width.

12. The IC of claim 11 wherein the transmitter is further configured to terminate the transmission of data over the at least one selected bit lane identified by the narrow link command while continuing to transmit data over at least one active bit lane of the I/O link.

13. The IC of claim 12 wherein the transmitter is further configured to power off the at least one selected bit lane identified by the narrow link command.

14. The IC of claim 12 wherein the receiver is configured to power off the at least one selected bit lane identified by the narrow link command while continuing to receive data from the transmitter over at least one active bit lane of the I/O link.

15. The IC of claim 14 wherein the receiver is further configured to transmit an acknowledgement message to the transmitter after the at least one selected bit lane identified by the narrow link command has been powered off.

16. The IC of claim 11 wherein the command is a widen link command, and the transmitter and the receiver are configured to power on the at least one selected bit lane identified by the widen link command while the transmitter continues to transmit data to the receiver over at least one active bit lane of the I/O link.

17. The IC of claim 16 wherein the receiver is further configured to transmit an acknowledgement message to the transmitter after the at least one selected bit lane identified by the widen link command has been powered on.

18. The IC of claim 17 wherein the transmitter and the receiver are configured to performing an I/O link training procedure.

19. The IC of claim 10 wherein the transmitter resides on one die of the IC, and the receiver resides on another die of the IC.

20. The IC of claim 10 wherein the transmitter is comprised by a first processor, and the receiver is comprised by a second processor.

21. The IC of claim 10 wherein the transmitter is comprised by a first I/O device, and the receiver is comprised by a second I/O device.

22. The IC of claim 10 wherein the transmitter is comprised by a first router, and the receiver is comprised by a second router.

23. A computer-readable storage medium configured to store a set of instructions used for manufacturing a semiconductor device, wherein the semiconductor device comprises:
a transmitter;
a receiver; and
an input/output (I/O) link established between the transmitter and the receiver, the I/O link having a plurality of bit lanes, wherein the transmitter is configured to send to the receiver a command identifying at least one selected bit lane of the I/O link that will be powered off or powered on in response to detecting that a bit width adjustment threshold of the I/O link has been reached.

24. The computer-readable storage medium of claim 23 wherein the instructions are Verilog data instructions.

25. The computer-readable storage medium of claim 23 wherein the instructions are hardware description language (HDL) instructions.
